(19) United States
(12) Patent Application Publication
(10) Pub. No.: US 2004/0206125 A1
(43) Pub. Date: Oct. 21, 2004

(54) Apparatus for treating glass flow

(76) Inventors: Christian Schenk, Ingelheim (DE); Hatto Schafer, Essenheim (DE)

Correspondence Address: Hatto Schafer, An der Klingelpforte 2, DE-55270, Essenheim, DE

(21) Appl. No.: 10/754,105

(22) Filed: Jan. 7, 2004

(30) Foreign Application Priority Data
Jan. 10, 2003 (DE) 103 00 563.3

(51) Int. Cl. C03B 5/26

(52) U.S. Cl. 65/325; 65/374.13; 65/374.15

(57) ABSTRACT

An apparatus for manufacturing glass using a feeding device, via which liquid glass can be supplied to a hot-shaping device. For precise setting of the operational parameters, such as glass temperature and viscosity, a glass flow treating apparatus, which has a flow path with a gradient that is inclined in a direction towards the hot-shaping device, is disposed in a region between the feeding device and the hot-shaping device.

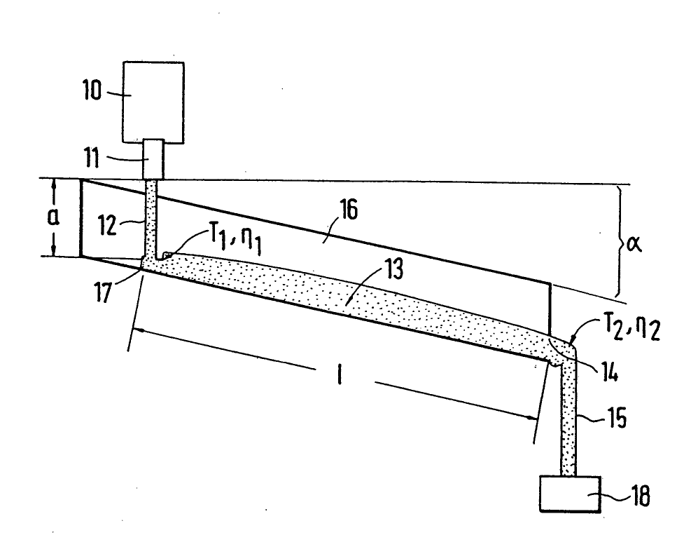

### BACKGROUND OF THE INVENTION

1. Field of the Invention

This invention relates to an apparatus for manufacturing glass, including a feeding device, via which the liquid glass can be supplied to a hot-shaping device.

2. Discussion of Related Art

In the manufacture of optical glass, for example lanthanum glass, the glass exiting the feeding device is supplied to a hot-shaping device. At this point the glass to be processed is too hot for many of the processes of hot-shaping and its viscosity is too low. The glass often does not have the necessary conditions for the hot-shaping operation with respect to its physical state and its characteristics. If the glass is supplied to the hot-shaping device via a fire-resistant material, for example platinum, this gives rise to a heterogeneous contact between the glass and the fire-resistant material, which leads to crystallisation processes, which can only be avoided through appropriately high temperatures. High temperatures relate to low feed viscosities, which provide problems of the formation of streaks, folds or cracks.

### SUMMARY OF THE INVENTION

It is one object of this invention to provide an apparatus of the above-mentioned type, but where the glass supplied to the hot-shaping device is treated with respect to its operational parameters, so that it becomes possible to hot-shape in an economical manner without forming streaks, folds or cracks.

This object is achieved according to this invention because in the region between the feeding device and the hot-shaping device there is disposed a glass flow treating apparatus, which has a flow path with a gradient, which is inclined in a direction towards the hot-shaping device. It is possible for liquid glass supplied from the feeding device to be influenced, regarding its operational parameters, such as temperature and viscosity, in a targeted manner in the region of this flow path and thus can be brought in line in an optimum manner with the optimum conditions necessary for the subsequent hot-shaping operation. It is thus possible to cool or heat the glass flow in the flow path. Where the flow path is cooled, the glass flows over a cooler layer made from “inherent glass”, such that the devitrification processes are restricted to homogeneous crystallisation processes, which have a much lesser effect on the supplied glass. Consequently, the formation of streaks, folds or cracks is avoided, as much as possible.

According to one preferred development of this invention, the conducting surface of the flow path is made from graphite or a ceramic material. The glass flows away in a controlled manner with this material selection. In one embodiment of this invention, the flow path is formed by a longitudinally halved pipe or a closed pipe.

There is a simple technical solution when the glass flow treating apparatus has an adjusting device, by which the flow path length extending in the direction of the gradient and/or the flow path gradient each is adjustable.

The influences on the operational parameters can be effected within the flow path such that, due to changes in the flow path length and/or the gradient, the dwell time of the glass in the flow path can also be varied. Consequently, more or less time is made available to the glass for altering its operational parameters. Thus, a setting device is associated with the feeding device or the flow path, by which the feed point of the glass deposited by the feeding device into the flow path is adjustable in the direction of the gradient of the flow path. Depending on the structural conditions of the manufacturing system, the feeding device or the hot-shaping device can be fixedly installed. Accordingly, for example, where the hot-shaping device is fixedly disposed, the feeding device can be positionable in a variable manner. Contrary to this, if the position of the feeding device cannot be changed, but the hot-shaping device can be repositioned, then the flow path can then be adjusted.

To be able to influence the temperature in a targeted manner, in one embodiment of this invention, at least one heating and/or cooling element is associated with the flow path. A control circuit can also be coupled to the heating or respectively cooling element. The control circuit detects the temperature of the glass within the flow path, for example, per pyrometer. The heating or cooling output is controlled depending on a required/actual comparison.

In one embodiment of this invention, the glass is treated at the exit point from the flow path so that it has the operational parameters necessary for the glass shaping operation. It is then provided that the treated glass, emerging from the glass flow treating apparatus, is conducted into the hot-shaping device directly following the flow path.

### BRIEF DESCRIPTION OF THE DRAWING

This invention is described in detail in view of one embodiment shown in the drawing.

### DESCRIPTION OF PREFERRED EMBODIMENTS

The single drawing is a schematic representation of a glass flow treating apparatus 16 with a feeding device 10 and a hot-shaping means or device 18. A glass flow treating apparatus 16 is disposed in the region between the feeding device 10 and the hot-shaping device 18. The glass flow treating apparatus 16 is, for example, in the form of a channel with a semicircular cross-section. The channel forms a flow path. The liquid glass coming out of the feeding device 10 can be supplied to the hot-shaping device 18 via this channel. As shown in the drawing, the flow path has a gradient. Proceeding from the feeding device 10, the liquid glass is dosed into the glass flow treating apparatus 16 via a feed nozzle 11. Forming an inherent glass layer 13, the glass flows to the hot-shaping device 18 via the flow path. The glass exits the flow path in the region of an outlet 14 formed at the end of the glass flow treating apparatus 16. A glass strand 15, which flows in the direction of gravity, is then conducted directly into the hot-shaping device 18. The flow path extends over the length “l” proceeding from a feed point 17 as far as the outlet 14. The parameters, such as temperature and viscosity, of the glass are modified near or in the region of the flow path and are brought to the values necessary for the hot-shaping operation.

The gradient, the angle of inclination a of the flow path, can be adjusted to alter the speed of flow. Thus, the dwell time of the glass in the glass flow treating apparatus 16 also can be adjusted.

Due to longer dwell times, the glass can, for example, be cooled to a lower temperature level. The adjusting of the dwell time of the glass can also be achieved alternatively or additionally by varying the position of the feed point 17. This can be displaced in the direction of the gradient. The feed point 17 is displaced either by displacing the feeding device 10 or the glass flow treating apparatus 16.

The channel formed by the glass flow treating apparatus 16 has on the inner walls graphite or ceramics material. At the beginning of the operation, the glass forms a layer made of “inherent glass” in the glass flow treating apparatus 16. In this case, the glass adheres at the contact point with the glass flow treating apparatus 16 so that the glass flows off over the forming glass layer. Thus, the following glass no longer has any direct contact with the glass flow treating apparatus 16. A heating/cooling operation possibly installed also provides a precise tempering of the glass in the glass flow treating apparatus 16.

As shown in the drawing, the glass strand 15 emerges from the feed nozzle 11 at a distance a from the glass flow treating apparatus 16 and thus from the feed point 17.

At the same time, the glass flow assumes a temperature T₁ at the feed point 17 and has an initial viscosity η₁. The speed of the glass and the volume of the glass can be adjusted by adjusting the inclination a of the glass flow treating apparatus 16. The length l of the inherent glass layer 13 and thus the initial state of the glass strand 15 at the start 14 can be adjusted by displacing the feed point 17, as shown by the temperature T₂ and the initial viscosity η2.

German Patent Reference 103 00 563.3, the priority document corresponding to this invention, and its teachings are incorporated, by reference, into this specification.

What is claimed is:

1. An apparatus for manufacturing glass, comprising: a feeding device (10) supplying a liquid glass to a hot-shaping device (18), a glass flow treating apparatus (16) disposed in a region between the feeding device (10) and the hot-shaping device (18), the glass flow treating apparatus (16) having a flow path with a gradient inclined in a direction towards the hot-shaping device (18).

2. The apparatus according to claim 1, wherein a glass conducting surface of the flow path is made of one of a graphite material and a ceramic material.

3. The apparatus according to claim 2, wherein the flow path is formed by one of a longitudinally halved pipe and a closed pipe.

4. The apparatus according to claim 3, wherein the glass flow treating apparatus (16) has an adjusting device for adjusting at least one of a flow path length (I) extending in a direction of a gradient and a flow path gradient (α).

5. The apparatus according to claim 4, wherein a setting device is associated with one of the feeding device (10) and the flow path, by which a feed point (17) of the glass (12) deposited by the feeding device (10) into the flow path is adjustable in the direction of the gradient of the flow path.

6. The apparatus according to claim 5, wherein at least one of a heating element and a cooling element is associated with the flow path.

7. The apparatus according to claim 6, wherein a treated glass (15) emerging from the glass flow treating apparatus (16) is conducted into the hot-shaping device (18) directly after the flow path.

8. The apparatus according to claim 1, wherein the flow path is formed by one of a longitudinally halved pipe and a closed pipe.

9. The apparatus according to claim 1, wherein the glass flow treating apparatus (16) has an adjusting device for adjusting at least one of a flow path length (I) extending in a direction of a gradient and a flow path gradient (a).

10. The apparatus according to claim 9, wherein a setting device is associated with one of the feeding device (10) and the flow path, by which a feed point (17) of the glass (12) deposited by the feeding device (10) into the flow path is adjustable in the direction of the gradient of the flow path.

11. The apparatus according to claim 1, wherein at least one of a heating element and a cooling element is associated with the flow path.

12. The apparatus according to claim 1, wherein a treated glass (15) emerging from the glass flow treating apparatus (16) is conducted into the hot-shaping device (18) directly after the flow path.
